(19) United States
(12) Patent Application Publication
(10) Pub. No.: US 2010/0074692 A1
(43) Pub. Date: Mar. 25, 2010

(54) Open-Sea Berth LNG Import Terminal

(76) Inventors: Mark E Ehrhardt, Houston, TX (US); William S. Mathews, Luanda (AO); Dawn L. Rymer, Pearland, TX (US); Paul W. Sibal, The Woodlands, TX (US); Robert E. Sandstrom, Sugar Land, TX (US); W. Brett Wilson, Sprint, TX (US); Mark A. Danaczko, Houston, TX (US); Robert D. Denton, Doha (QA); Robert E. Foglesong, Houston, TX (US)

Correspondence Address: Exxon Mobil Upstream;Research Company, P.O. Box 2189, (CORP-URC-SW 359), Houston, TX, 77252-2189, US

(21) Appl. No.: 12/375,927

(22) PCT Filed: Jul. 23, 2007
(86) PCT No.: PCT/US07/16546

§ 371 Date: Nov. 13, 2009

Related U.S. Application Data
(60) Provisional application No. 60/843,729, filed on Sep. 11, 2006.

(51) Int. Cl. E02B 17/00; F17C 9/02; B65D 88/78; B65G 67/60

(52) U.S. Cl. 405/203; 62/50.2; 114/256; 414/803

(57) ABSTRACT

Methods and systems for receiving liquefied natural gas (LNG) and delivering vaporized natural gas to a pipeline in fluid communication with onshore equipment and methods for importing LNG. In one embodiment, an open-sea berth import terminal includes a platform, which is fixed to the sea floor and includes two or more sets of berthing structures. LNG carriers berth at the open-sea berth import terminal to transfer LNG to a storage vessel moored at one of the berthing structures. LNG vaporization facilities, either on the storage vessel or the platform, vaporize the LNG prior to delivery to the pipeline. The storage vessel may include a barge or another LNG carrier. In other embodiments, the open-sea berth import terminal may have no storage facilities, but two LNG carriers may berth at the berthing structures to concurrently perform offloading operations, with one transferring LNG and the other performing other offloading operations to enhance operations.

### CROSS REFERENCE TO RELATED APPLICATIONS

This application claims the benefit of U.S. Provisional Application No. 60/843,729, filed 11 Sep. 2006.

### BACKGROUND OF THE INVENTION

1. Field of the Invention

The invention relates to the delivery of liquefied natural gas (LNG) via ships to LNG import terminals in various markets throughout the world. In particular, this invention is concerned with LNG delivery to offshore LNG import terminals.

2. Discussion of Background Information

After natural gas is produced, processed and liquefied, it is delivered to market locations, such as LNG import terminals, by LNG carriers. An LNG import terminal receives the LNG from the LNG carriers and vaporizes the LNG into natural gas to be transmitted to other markets by a natural gas pipeline. Onshore LNG import terminals are typically difficult to establish and in some situations may not be permitted. As a result, offshore LNG import terminals, where the vaporized LNG is transferred to shore by a natural gas pipeline, are an attractive solution.

Proposed offshore LNG import terminals with LNG storage and vaporization include gravity based structures (GBSs) and floating storage and regasification units (FSRUs). Other offshore LNG import terminal concepts have no LNG storage capability, and depend on vaporization facilities onboard the LNG carrier to provide vaporized LNG directly into the natural gas pipeline to shore. These types of offshore LNG import terminals may not achieve cost parity with onshore LNG import terminals, depending on the region of the world in which the offshore LNG import terminal is located.

GBS offshore terminals typically use a concrete structure to hold the LNG storage tanks and provide a deck on which the cryogenic cargo transfer equipment and LNG vaporization facilities are installed. In other GBS offshore terminals, a steel structure may be used instead of the concrete structure. For these GBS offshore terminals, LNG carriers are berthed and subsequently moored alongside the GBS offshore terminal and LNG is offloaded through cryogenic loading arms. A natural gas pipeline is installed from the GBS offshore terminal to an interconnection point of the pipeline grid, which can be onshore or offshore. Although the GBS offshore terminal may be physically located near the shoreline, which decreases pipeline length and cost, relatively weak local soil conditions at the location of the GBS offshore terminal affect its design and can increase the associated costs by requiring increasingly complex and costly structures for on-bottom stability.

Further, an FSRU is a moored floating structure used to hold the LNG storage tanks. The FSRU may incorporate a turret-mooring system that allows the FSRU to rotate (or weathervane) in response to the prevailing wind, wave and current conditions. Similar to the GBS offshore terminal, an LNG carrier is berthed and moored alongside the FSRU and LNG is offloaded through cryogenic loading arms. The cryogenic cargo transfer equipment and LNG vaporization facilities are located on the deck of the FSRU with the vaporized LNG being sent through the turret into the natural gas pipeline through a flexible riser. Unfortunately, with FSRUs, the necessary water depth is generally greater, compared to the GBS, to be able to accommodate the motions of the FSRU in extreme weather conditions. That is, depending on the bathymetry of the specific location, the FSRU may have to be located a great distance offshore, to provide the required water depth, thus, increasing the length of natural gas pipeline and the associated costs.

Finally, for offshore LNG import terminals that have no associated liquid storage, each individual LNG carrier has LNG vaporization equipment installed, and is capable of transferring natural gas through a disconnectable turret-mooring system into the natural gas pipeline through a flexible riser. The disadvantage of this type of offshore LNG import terminal is in the delivery of LNG over relatively long distances or at higher volumes. In these situations, the number of LNG carriers in a shipping fleet that provides the natural gas is increased, and the associated costs of installing LNG vaporization facilities and other modifications on each LNG carrier dramatically increases the overall cost of LNG delivery.

As such, an offshore LNG terminal is needed that may avoid the problems associated with onshore LNG terminals and maintain the economical aspects of onshore LNG import terminals.

Additional related material may be found in U.S. Pat. No. 3,590,407; U.S. Pat. No. 5,549,164; U.S. Pat. No. 6,003,603; U.S. Pat. No. 6,089,022; U.S. Pat. No. 6,546,739; U.S. Pat. No. 6,637,479; U.S. Pat. No. 6,880,348; U.S. Pat. No. 6,923,225; U.S. Pat. No. 7,080,673; U.S. Published Application No. 2002/0073619; U.S. Patent Application Publication No. 2002/0174662; U.S. Patent Application Publication No. 2004/0187385; U.S. Published Application No. 2005/0039665; U.S. Published Application No. 2005/0139595; U.S. Published Application No. 2005/0140968; U.S. Patent Application Publication No. 2006/0010911; European Patent Application No. 1,383,676; International Patent Application No. WO 01/03793; International Patent Application No. W02006/044053; and International Published Application No. WO 2005/056379. Furthermore, other information may be found in Loez, Bernard “New Technical and Economic Aspects of LNG Terminals,” Petrole Information, pp. 85-86, August 1987; Hans Y. S. Han et al., “Design Development of FSRU from LNG Carrier and FPSO Construction Experiences,” Offshore Technology Conference May 6-9, 2002, OTC-14098; “The Application of the FSRU for LNG Imports,” Annual GAP Europe Chapter Meeting Sep. 25-26, 2003; and O. B. Larsen et al., “The LNG (Liquefied Natural Gas) Shuttle and Regas Vessel System,” Offshore Technology Conference May 3-6, 2004, OTC-16580.

### SUMMARY OF THE INVENTION

The present invention relates to an offshore open-sea berth terminal that may reduce permitting issues while maintaining cost parity with onshore terminals.

In a first embodiment, an open-sea berth terminal is described. The open-sea berth terminal is used for importing a carrier load, and includes a platform secured to a seafloor and a pipeline operatively coupled to the platform and in fluid communication with onshore equipment. The importing of a carrier load may include offloading, receiving or otherwise transferring the carrier load between two locations, which may include transporting the cargo load in international and/or territorial waters. The terminal also includes at least two sets of structures associated with the platform, wherein each of the at least two sets of structures are associated with berthing and mooring vessels. The terminal also includes a storage vessel berthed and moored at a first of the at least two sets of structures, the storage vessel adapted to transfer a carrier load between a carrier vessel operatively coupled to a second of the at least two sets of structures and the storage vessel, wherein the storage vessel is in fluid communication with the pipeline. The carrier load may be liquefied natural gas (LNG).

In a second embodiment, an open-sea berth LNG import terminal for offshore delivery of imported LNG is described. The open-sea berth LNG import terminal includes a platform fixed to a seafloor and a pipeline operatively coupled to the platform and in fluid communication with onshore equipment. The open-sea berth LNG import terminal also includes at least two sets of structures associated with the platform and configured to berth and moor vessels along with a storage vessel berthed and moored at a first of the at least two sets of structures. The storage vessel is adapted to store LNG and transfer LNG between a carrier vessel berthed and moored at a second of the at least two sets of structures and the storage vessel. Further, the open-sea berth LNG import terminal includes facilities on at least one of the platform and the storage vessel, wherein the stored LNG is vaporized by the facilities prior to delivery to the pipeline.

In a third embodiment, a method for importing LNG using an open-sea berth LNG import terminal fixed to a sea floor and associated with at least two sets of structures used for berthing and mooring vessels and in fluid communication with a pipeline coupled to onshore facilities is described. The method includes berthing and mooring an LNG carrier at a first of at least two sets of structures; berthing and mooring a storage vessel at a second of the at least two sets of structures; offloading LNG from the LNG carrier to the storage vessel using cryogenic cargo transfer equipment; vaporizing the LNG from the storage vessel using facilities; and delivering the vaporized LNG to the pipeline. The method further includes disconnecting (i.e. deberthing) the LNG carrier after it unloads while maintaining the storage vessel at the second of the at least two sets of structures. In the event of adverse weather conditions, the storage vessel can be deberthed and moved to safe waters, using tug boats and/or its own maneuvering and propulsion systems.

In a fourth embodiment, the method for importing LNG is described. The method comprises berthing and mooring a first LNG carrier at a first structure associated with an open-sea berth import terminal fixed to a seafloor and coupled to a pipeline in fluid communication with onshore facilities; offloading LNG from the first LNG carrier to the open-sea berth import terminal using cryogenic cargo transfer equipment; vaporizing the LNG from the first LNG carrier at the open-sea berth import terminal; delivering the vaporized LNG to the pipeline; berthing and mooring a second LNG carrier to a second structure associated with an open-sea berth import terminal to prepare cryogenic cargo transfer equipment for offloading while the first LNG carrier is offloading at the first structure; initiating the offloading of LNG from the second LNG carrier after offloading of the LNG from the first LNG carrier is complete; and preparing the first LNG carrier for deberthing while the second LNG carrier is offloading.

In a fifth embodiment, the method for importing LNG is described. The method comprises berthing and mooring a first LNG carrier at a first structure associated with an open-sea berth import terminal fixed to a seafloor and coupled to a pipeline in fluid communication with onshore facilities; berthing and mooring a second LNG carrier at a second structure associated with the open-sea berth import terminal; transferring LNG from the first LNG carrier to the open-sea berth import terminal using cryogenic cargo transfer equipment; vaporizing the LNG from the first LNG carrier at the open-sea berth import terminal; and performing other offloading operations with the second LNG carrier concurrently with the transfer of LNG from the first LNG carrier. The method may also include delivering the vaporized LNG to the pipeline, while the second LNG carrier is performing other offloading operations; wherein the other offloading operations comprise connecting, cooling down and disconnecting cryogenic cargo transfer equipment; completing the offloading operation of the first LNG carrier; vaporizing the LNG from the second LNG carrier at the open-sea berth import terminal; delivering the vaporized LNG from the second LNG carrier to the pipeline; deberthing the first LNG carrier from the first structure; and berthing and mooring another LNG carrier at the first structure, while the second LNG carrier is transferring LNG.

In one or more of the embodiments above, various other features may also be present. For instance, the open-sea berth terminal may be an import terminal; the pipeline may provide natural gas to the onshore equipment; and the carrier load may be liquefied natural gas (LNG); and the carrier load may be transferred from the carrier vessel to the storage vessel and then to the platform for delivery of natural gas into the pipeline. Also, the platform may comprise facilities to vaporize the LNG prior to delivery into the pipeline; at least one of living quarters, maintenance facilities, safety systems, emergency escape and evacuation systems, logistics systems and power generation; cryogenic loading arms for transferring the LNG; cryogenic hoses for transferring the LNG; a steel truss support structure or concrete column structure to fix the platform to the seafloor. The steel truss support structure may include generally vertical legs connected by structural members and piles extend through the generally vertical legs into the seafloor to pin the steel truss support structure to the seafloor. The concrete column structure may include buoyancy chambers; piles extend through the concrete column into the seafloor to pin the concrete support structure to the seafloor; and a skirt that sinks into the seafloor. Further, the at least two sets of structures may be anchored to the seafloor; may be positioned on opposite sides of the platform; and/or may each of the at least two sets of structures comprise berthing dolphins fixed to the seafloor and mooring dolphins fixed to the seafloor.

The storage vessel may include different aspects in one or more of the embodiments. For instance, the storage vessel may be a barge equipped with storage tanks for containing LNG. Alternatively, the storage vessel may be another LNG carrier including the necessary tanks. Another LNG carrier could be acquired as a ship which already includes propulsion and navigation systems. For instance, the storage vessel may be a barge having storage tanks for containing LNG; may have storage tanks being self-supporting prismatic tanks, spherical tanks, membrane tanks, and modular tanks; may have facilities for vaporizing the LNG and a transfer system for delivering vaporized LNG from the barge to the platform; may have at least one of living quarters, maintenance facilities, safety systems, emergency escape and evacuation systems, logistics systems and power generation; may have maneuvering and propulsion systems for deberthing the barge (e.g. berthing operations). Also, the storage vessel may be an LNG carrier with tanks and accommodations for marine operation. Regardless, the LNG may be transferred between the carrier, the storage vessel and the platform by transfer systems, which include cryogenic loading arms or hoses.

In another embodiment, no storage vessel may be used. Instead, the open-sea LNG import terminal berths and moors two LNG carriers simultaneously. The method for importing LNG using two LNG carriers begins with berthing and mooring a first LNG carrier at a first berthing structure associated with an open-sea berth LNG import terminal fixed to the seafloor and coupled to a pipeline in fluid communication with onshore facilities. Next, the LNG from the first LNG carrier is offloaded to the open-sea berth LNG import terminal using cryogenic cargo transfer equipment. The offloaded LNG is vaporized and delivered to the pipeline. While the first LNG carrier is offloading at the first berthing structure, a second LNG carrier is berthed and moored to a second berthing structure associated with an open-sea berth LNG import terminal to begin offloading preparations. After offloading of LNG from the first LNG carrier is complete, the LNG from the second carrier is offloaded. The first LNG carrier is then prepared for deberthing while the second LNG carrier is offloaded. In this way, two carriers can be offloaded successively and berthed and moored concurrently, while one is offloading and the other is preparing to offload. Thus, a continuous supply of LNG is provided to the platform for vaporization.

Further still, one or more of the embodiments may include other aspects of the present invention. For instance, the method may include the storage vessel being a barge and deberthing the storage vessel comprises moving the barge via maneuvering and propulsion systems disposed on the barge; the deberthing further comprises utilizing other vessels to move the barge; the storage vessel being another LNG carrier and deberthing the storage vessel comprises moving the another LNG carrier using a marine operation propulsion system disposed on the LNG carrier; the deberthing further comprises assisting the movement of another LNG carrier utilizing other vessels; the storage vessel being a barge having tanks, the offloading further comprising filling the tanks with LNG using the cryogenic cargo transfer equipment; and the storage vessel being another LNG carrier having tanks, the offloading further comprising filling the LNG carrier tanks with LNG using the cryogenic cargo transfer equipment. Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 is a schematic plan view of the open-sea berth LNG import terminal in accordance with one embodiment of the present invention;

FIG. 2 is a schematic side view of the open-sea berth LNG import terminal of FIG. 1 using a steel truss-like support in accordance with one embodiment of the present invention;

FIG. 3 is a side view of the open-sea berth LNG import terminal of FIG. 1 in an alternative embodiment using a concrete column support in accordance with one embodiment of the present invention; and

FIG. 4 is a schematic of a storage barge utilizing another mooring approach for securing to the open-sea berth LNG import terminal in accordance with one embodiment of the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present invention relates to methods and assemblies for delivery and import of LNG via vessels to an open-sea berth LNG terminal in various markets throughout the world. In some embodiments, a LNG loading platform, secured or fixed to the seafloor, is equipped with cryogenic loading arms specially designed to accommodate LNG carrier motions in the offshore environment during offloading operations, such as connecting to facilities, LNG transferring and disconnecting from facilities. In particular, the open-sea berth LNG import terminal may receive LNG from an LNG carrier, process the LNG on the loading platform or a storage vessel and provide vaporized LNG to a pipeline for distribution to onshore equipment. The loading platform of the open-sea berth LNG import terminal may be supported using a steel truss or steel truss-like structure or a concrete column.

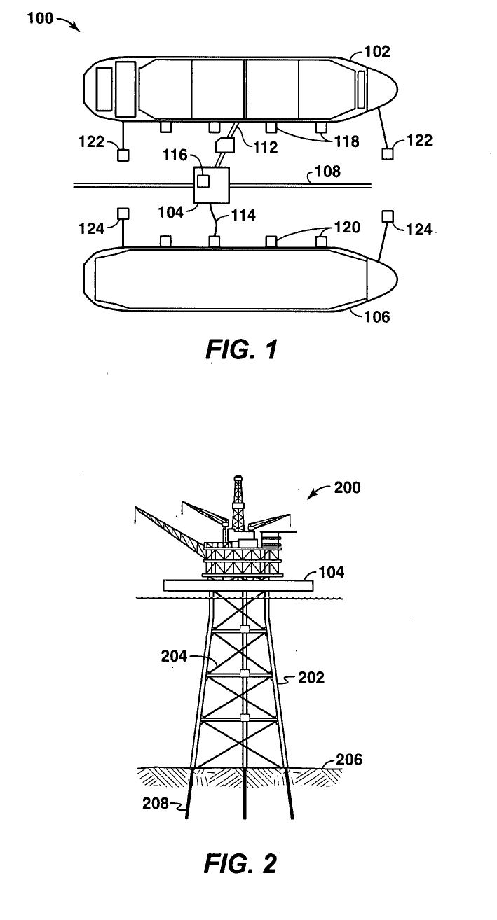

FIG. 1 is an exemplary open-sea berth LNG import terminal 100 in accordance with one embodiment of the present invention. The open-sea berth LNG import terminal 100 may be secured or fixed to the seafloor in an open sea environment to berth, moor and offload LNG from one or more vessels, such as a LNG carrier 102 and a storage vessel 106. The LNG carrier 102 may be equipped with typical systems for propulsion and navigation along with accommodations for marine operations. Once processed by the equipment on the open-sea berth LNG import terminal 100, the resulting vaporized LNG may be transferred to onshore facilities (not shown) via a pipeline 108 (i.e. natural gas pipeline). The pipeline 108 provides a flow path for vaporized LNG from the loading platform to onshore equipment, where it may be further processed or distributed. The pipeline 108 is designed for pressure export rates and pressure requirements specified by the gas distribution system.

To provide the vaporized LNG to the pipeline 108, the open-sea berth LNG import terminal 100 may include various facilities positioned on a loading platform 104 and utilized to transfer and process the LNG. For instance, the open-sea berth LNG import terminal 100 may include LNG vaporization facilities 116 as well as other ancillary systems (not shown) positioned on the loading platform 104, such as living quarters and maintenance facilities, safety systems, emergency escape and evacuation systems, logistics systems, power generation and other utilities to support terminal operations. In addition, the open-sea berth LNG import terminal 100 is equipped with cryogenic loading arms or hoses 112 and 114 to facilitate transfer of LNG from the LNG carrier 102, to the loading platform 104, and to another vessel 106 for storage. The cryogenic loading arms 112 or 114 may be designed to accommodate LNG carrier motions in the offshore environment during offloading operations, such as connection, LNG transfer and disconnection. Cryogenic hoses 114 or 112 provide additional flexibility to accommodate movement of the LNG carrier 102 or the storage vessel 106. The cryogenic loading arms or hoses 112 and 114 can each be utilized for either or both of the carrier 102 or storage 106 vessels as conditions or design availability dictate. Because of the stability of the open-sea berth LNG import terminal 100, installed LNG vaporization facilities 116 may be any of a variety of conventional types of equipment that are used in an onshore LNG import terminal, such as heat exchangers, pumps and compressors. See, e.g., U.S. Pat. No. 6,546,739. The LNG vaporization facilities 116 convert the LNG offloaded from the LNG carrier 102 into its gaseous state.

To secure the LNG carrier 102 and storage vessel 106, the loading platform 104 includes one or more berthing structures (referred to as mooring or berthing dolphins), such as berthing structures 118, 120, 122 and 124. The berthing structures 118, 120, 122 and 124 used to moor the vessels adjacent the loading platform 104 may be fixed to the seafloor or the platform 104. Mooring dolphins, such as berthing structures 122 and 124, secure mooring lines from the LNG carrier 102 or storage vessel 106. Berthing dolphins, such as berthing structures 118 and 120, are structures in contact with a vessel to restrain its motion while also providing additional points for securing mooring lines. As such, a set of berthing structures may refer to berthing dolphins 118 and mooring dolphins 122 or berthing dolphins 120 and mooring dolphins 124.

In FIG. 1, the berthing structures 118 and 122 may be fixed to the seafloor to moor the LNG carrier 102 while the LNG is transferred to the loading platform 104. The first set of structures 118 and 122 may include dolphins and fenders necessary to enable an LNG carrier to berth in a manner similar to that done at an onshore LNG import or export terminal. The second set of structures 120 and 124 may also be fixed to the seafloor to moor the storage vessel 106. The second set of structures 120 and 124, which may be on the opposite side of the loading platform 104, are occupied on a nominally continuous basis by an LNG storage vessel 106.

In an exemplary offloading operation, the LNG carrier 102 approaches the berthing structures 118 and 122. The LNG carrier 102 may utilize tugboats (not shown) to assist in the berthing operations adjacent to the loading platform 104. Once the berthing operations are complete, the cryogenic loading arms or hoses 112 or 114 are connected to the LNG carrier's cargo manifold, typically located near midships of the LNG carrier 102. Once the cryogenic cargo transfer equipment (cryogenic loading arms or hoses 112 and 114 and all associated piping) are prepared for offloading, LNG is transferred from the LNG carrier 102 into the storage vessel 106. The stored LNG is converted into natural gas by LNG vaporization facilities 116 and delivered to the pipeline 108. Once the LNG transfer operations are complete, the cryogenic loading arms 112 are disconnected from the LNG carrier's cargo manifold, and the LNG carrier 102 deberths from the berthing structure 118 ands 122, while the storage vessel 106 remains at its berth. Another LNG carrier can then be moored at the vacated berth to continue the process.

Using this technique, an open-sea LNG import terminal 100 can be used to deliver vaporized LNG directly to shore through the pipeline 108. Unlike a GBS terminal, LNG can be stored on a floating storage vessel, requiring no LNG storage tanks on the platform. Unlike an FSRU, the open-sea LNG import terminal platform can be located in shallower water and therefore closer to shore, which decreases the pipeline length and its associated costs.

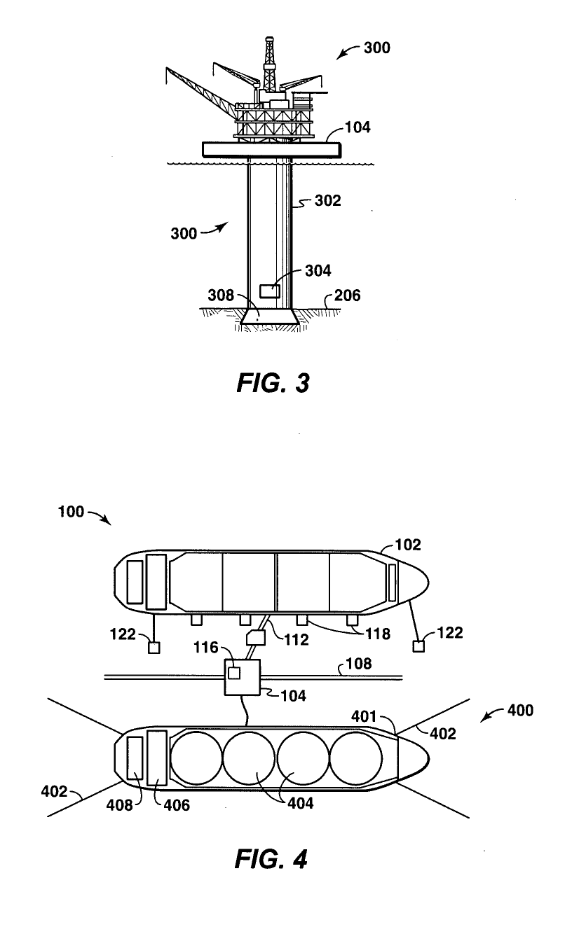

Various support structures may be utilized to secure the open-sea berth LNG import terminal 100 to the sea floor. With these support structures, exemplary illustrations of which are shown in FIGS. 2 and 3, the open-sea berth LNG import terminal 100 may be positioned at any geophysical location, which is typically not possible for GBS import terminals. For instance, FIG. 2 is an illustration of an embodiment of the open-sea berth LNG import terminal 100 that includes a steel truss or steel truss-like support structure 200 to support the loading platform 104. The steel truss-like support structure 200 includes vertical or near vertical legs 202 connected by structural members 204. The steel truss-like support structure 200 is secured to the seabed or seafloor 206, such as by piles 208 through the legs 202 or secured to the legs 202, which may be driven or drilled into the seabed 206. If installed by drilling, the steel piles 208 are grouted into place in the seabed 206. The distance the piles 208 are driven or drilled into the seabed 206 may be based upon the severity of the wind, waves and current at the location and the nature of the seabed soils.

As an alternative embodiment, the loading platform 104 of the open-sea berth LNG import terminal 100 can be supported by a concrete structure 300, such as one or more concrete column(s), as shown in FIG. 3. The concrete structure 300 may be a cylindrical concrete column 302 constructed with buoyancy chambers 304 that permit the concrete structure 300 to be installed by floating it into position and then sinking the concrete column to the seabed 206 by flooding the buoyancy chambers 304. Again, the concrete structure 300 may be secured to the seabed with piles (not shown) driven or drilled through the concrete structure 300 similar to the discussion above for the steel truss-like support structure 200. As another approach, the concrete structure 300 may be equipped with a skirt 308 that sinks into the seabed under the weight of the concrete structure 300 such that the concrete structure 300 remains in place because of its weight. The use of a concrete column as the concrete structure may be limited to locations with adequate soil strength.

In addition to the different support structures, other mooring systems may be used for vessels associated with the open-sea berth LNG import terminal 100. That is, a spread mooring system may be beneficial in certain weather and sea conditions for certain vessels. In particular, a spread mooring system may be used for the storage vessel 106, as shown in FIG. 4. In a spread mooring system 400, multiple mooring lines 402 are utilized to restrict the heading of the vessel 106. One end of the mooring lines 402 is attached to the vessel 106 to be moored and the other end is attached to anchors or piles (not shown) on the seafloor. The mooring lines 402 are equipped with flotation devices (not shown) when disconnected from the vessel 106 to facilitate their retrieval during vessel mooring. This type of mooring does not utilize berthing dolphins and therefore the vessel 106 can be moored far enough from the loading platform to prevent contact during the certain environmental conditions.

In FIG. 4, the storage vessel 106 may be a barge modified to provide storage capability or another LNG carrier 102. The storage vessel 106 may include tanks 404 that are utilized to store the LNG. The tanks 404 may include various types of LNG tank designs that are suitable, such as membrane, self-supporting prismatic (SPB), spherical and rectangular (modular) tanks. Membrane tanks are typically made with an inner liner of stainless steel or a specialized alloy insulated from but supported by the vessel hull structure. Non-membrane tanks are spherical, prismatic or rectangular in shape and are typically free standing, made of aluminum or nickel steel. As can be appreciated, membrane tanks may be constructed in place within the hull, while the freestanding types can be fabricated separately from the vessel 106 and mounted to the vessel 106 in discrete units.

Under normal conditions, the storage vessel 106 is moored with the spread mooring system adjacent to the open-sea berth LNG import terminal 100 with cryogenic loading arms 114 permanently connected. In the event of adverse weather, which may produce vessel motions and subsequently forces that exceed the capability of the mooring system, the storage vessel 106 can deberth and move to a location that is not experiencing the adverse weather. Depending on the type of storage vessel 106, such as a barge, LNG carrier, or other storage vessel, tugboats may assist in this movement.

In addition, if the loading platform 104 of the open-sea berth LNG import terminal 100 does not include LNG vaporization facilities 116, then the storage vessel 106, such as a barge or LNG carrier 102, may be equipped with LNG vaporization or regasification facilities 406, as shown in FIG. 4. The LNG vaporization facilities 406 may include similar equipment to that discussed above in FIG. 1. The vessel 106 may also include maneuvering and propulsion systems 408.

To operate in this embodiment, the LNG carrier 102 can again be moored at the first berthing structures 118 and 122 and the storage vessel 106 may be moored adjacent to the LNG vessel 102 or the open-sea berth LNG import terminal 100. Suitable cryogenic cargo transfer equipment, such as the cryogenic loading arms or hoses 112 and 114, may deliver LNG from the LNG carrier 102 across the loading platform 104 to the storage vessel 106. Then, on the storage vessel 106, the LNG is vaporized by the LNG vaporization facilities 406. The vaporized LNG is transferred from the storage vessel 106 to the pipeline 108 at the loading platform 106.

Another possible embodiment may include an open-sea berth LNG import terminal that has no LNG storage, but has LNG vaporization facilities 116. In referring to FIG. 1, although there is no storage vessel 106 in this embodiment, the second berthing structures 120 and 124 provide a location for a second LNG carrier to berth, moor and prepare the cryogenic cargo transfer equipment for offloading before the first LNG carrier 102 has completed its offloading operations. This arrangement provides no interruption in natural gas delivery because of the ability to perform simultaneous berthing, mooring and deberthing operations. That is, the offloading operations may be performed by two or more LNG carriers successively, without downtime for berthing, mooring and offloading preparations. In this embodiment, the LNG carriers may unload at a reduced rate that is closer to the pipeline's flow rate (i.e. market send out rate). In some situations, this arrangement may involve at least one additional LNG carrier to be added to a transportation fleet to make up for delays associated with longer periods of time at the berth for offloading operations.

An example of these operations is described with reference to FIG. 1. A first LNG carrier 102 may be berthed and moored at the first berthing structures 118 and 122 and a second LNG carrier, which is vessel 106, may be berthed and moored at the second berthing structures 120 and 124. The first LNG carrier 102 may offload the LNG directly to the LNG vaporization facilities 116, while the second LNG carrier prepares the cryogenic cargo transfer equipment for offloading. The vaporized LNG from the first LNG carrier 102 is transferred to the pipeline 108. Once offloaded, the first LNG carrier 102 prepares for departure, while the second LNG carrier begins to offload its cargo to the LNG vaporization facilities 116. Another LNG carrier may berth and moor in the location previously held by the first LNG carrier once it is vacated. In this manner, the offloading operations may be performed concurrently with one LNG carrier transferring LNG and the other performing other preparations, such as berthing, mooring, and connecting and disconnecting cryogenic cargo transfer equipment.

It is noted that the foregoing examples have been provided merely for the purpose of explanation and are in no way to be construed as limiting of the present invention. While the present invention has been described with reference to exemplary embodiments, it is understood that the words that have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An open-sea berth terminal comprising:
a platform secured to a seafloor;
a pipeline operatively coupled to the platform and in fluid communication with onshore equipment;
at least two sets of structures adjacent to the platform, each of the at least two sets of structures associated with berthing and mooring vessels; and
a storage vessel berthed and moored to a first of the at least two sets of structures, the storage vessel adapted to transfer a carrier load between a carrier vessel operatively coupled to a second of the at least two sets of structures and the storage vessel and in fluid communication with the pipeline.

2. The open-sea berth terminal of claim 1, wherein the open-sea berth terminal is an import terminal, the pipeline provides natural gas to the onshore equipment, and the carrier load is liquefied natural gas (LNG), whereby the carrier load is transferred from the carrier vessel to the storage vessel and then to the platform for delivery of natural gas into the pipeline.

3. The open-sea berth terminal of claim 2, wherein the platform comprises facilities to vaporize the LNG prior to delivery into the pipeline.

4. The open-sea berth terminal of any of claims 1-3, wherein the platform further comprises at least one of living quarters, maintenance facilities, safety systems, emergency escape and evacuation systems, logistics systems and power generation.

5. The open-sea berth terminal of any of claims 2-4, wherein the platform comprises cryogenic loading arms for transferring the LNG.

6. The open-sea berth terminal of any of claims 2-5, wherein the platform comprises cryogenic hoses for transferring the LNG.

7. The open-sea berth terminal of any of claims 1-6, wherein the platform is fixed to the seafloor by a steel truss support structure.

8. The open-sea berth terminal of claim 7, wherein the steel truss support structure comprises generally vertical legs connected by structural members.

9. The open-sea berth terminal of any of claims 7-8, wherein piles are secured by one of extending the piles through the generally vertical legs into the seafloor to pin the steel truss support structure to the seafloor and attaching the piles to the steel truss support structure with piles extending into the seafloor to pin the steel truss support structure to the seafloor.

10. The open-sea berth terminal of any of claims 1-10, wherein the platform is fixed to the seafloor by a concrete column structure.

11. The open-sea berth terminal of claim 10, wherein the concrete column structure comprises buoyancy chambers.

12. The open-sea berth terminal of claim 10, wherein piles extend through the concrete column into the seafloor to pin the concrete support structure to the seafloor.

13. The open-sea berth terminal of claim 10, wherein the concrete column comprises a skirt that sinks into the seafloor.

14. The open-sea berth terminal of any of claims 1-13, wherein the at least two sets of structures are anchored to the seafloor.

15. The open-sea berth terminal of claim 14, wherein the at least two sets of structures are positioned on opposite sides of the platform.

16. The open-sea berth terminal of claim 14, wherein each of the at least two sets of structures comprise berthing dolphins fixed to the seafloor and mooring dolphins fixed to the seafloor.

17. The open-sea berth terminal of any of claims 2-16, wherein the storage vessel is a barge having storage tanks for containing LNG.

18. The open-sea berth terminal of claim 17, wherein the storage tanks are self-supporting prismatic tanks.

19. The open-sea berth terminal of claim 17, wherein the storage tanks are spherical tanks.

20. The open-sea berth terminal of claim 17, wherein the storage tanks are membrane tanks.

21. The open-sea berth terminal of claim 17, wherein the storage tanks are modular tanks.

22. The open-sea berth terminal of claim 17, wherein the barge comprises facilities for vaporizing the LNG and a transfer system for delivering vaporized LNG from the barge to the platform.

23. The open-sea berth terminal of claim 22, wherein the barge further comprises at least one of living quarters, maintenance facilities, safety systems, emergency escape and evacuation systems, logistics systems and power generation.

24. The open-sea berth terminal of any of claims 17-23, wherein the barge comprises maneuvering and propulsion systems for deberthing the barge.

25. The open-sea berth terminal of claims any of 2-24, wherein the storage vessel is an LNG carrier with tanks and accommodations for marine operation.

26. An open-sea berth LNG import terminal for offshore delivery of imported liquefied natural gas (LNG) comprising:
a platform fixed to a seafloor;
a pipeline operatively coupled to the platform and in fluid communication with onshore equipment;
at least two sets of structures associated with the platform and configured to berth and moor vessels;
a storage vessel berthed and moored to a first of the at least two sets of structures and adapted to store LNG, the storage vessel adapted to transfer LNG between a carrier vessel berthed and moored to a second of the at least two sets of structures and the storage vessel; and
facilities on at least one of the platform or the storage vessel, wherein the stored LNG is vaporized by the facilities prior to delivery to the pipeline.

27. The open-sea berth LNG import terminal of claim 26, wherein the storage vessel comprises a barge.

28. The open-sea berth LNG import terminal of claim 27, wherein the barge comprises maneuvering and propulsion systems for deberthing operations.

29. The open-sea berth LNG import terminal of any of claims 27-28, wherein the barge comprises the facilities.

30. The open-sea berth LNG import terminal of any of claims 26-29, wherein the LNG is stored in self-supporting prismatic tanks.

31. The open-sea berth LNG import terminal of any of claims 26-30, wherein the LNG is stored in spherical tanks.

32. The open-sea berth LNG import terminal of any of claims 26-31, wherein the LNG is stored in membrane tanks.

33. The open-sea berth LNG import terminal of any of claims 26-32, wherein the LNG is stored in modular tanks.

34. The open-sea berth LNG import terminal of any of claims 26-33, wherein the facilities are disposed on the platform along with a transfer system for delivering vaporized LNG from the storage vessel to the platform.

35. The open-sea berth LNG import terminal of claim 34, wherein the facilities further comprise at least one of living quarters, maintenance facilities, safety systems, emergency escape and evacuation systems, logistics systems and power generation.

36. The open-sea berth LNG import terminal of any of claims 26-35, wherein the platform comprises cryogenic loading arms for transferring the LNG.

37. The open-sea berth LNG import terminal of any of claims 26-36, wherein the platform comprises cryogenic hoses for transferring the LNG.

38. The open-sea berth LNG import terminal of any of claims 26-37, wherein the platform is fixed to the seafloor by a steel truss support structure.

39. The open-sea berth LNG import terminal of any of claims 26-38, wherein the platform is fixed to the seafloor by a concrete structure.

40. The open-sea berth LNG import terminal of any of claims 26-39, wherein the at least two sets of structures are anchored to the seafloor.

41. The open-sea berth LNG import terminal of claim 40, wherein each of the at least two sets of structures comprises berthing dolphins fixed to the seafloor and mooring dolphins fixed to the seafloor.

42. The open-sea berth LNG import terminal of any of claims 26-41, wherein the first and the second of the at least two sets of structures are located on opposite sides of the platform.

43. The open-sea berth LNG import terminal of any of claims 26-42, wherein the storage vessel is an LNG carrier having tanks to store the LNG and accommodations for marine operation.

44. A method for importing liquefied natural gas (LNG) using an open-sea berth import terminal fixed to a seafloor and associated with at least two sets of structures used for berthing and mooring vessels and in fluid communication with a pipeline coupled to onshore facilities, the method comprising:
berthing and mooring an LNG carrier at a first of at least two sets of structures;
berthing and mooring a storage vessel at a second of the at least two sets of structures;
offloading LNG from the LNG carrier to the storage vessel using cryogenic cargo transfer equipment;
vaporizing the LNG from the storage vessel using facilities; and
delivering the vaporized LNG to the pipeline.

45. The method of claim 44, wherein each of the at least two sets of structures comprise berthing dolphins fixed to the seafloor and mooring dolphins fixed to the seafloor.

46. The method of any of claims 44-45, further comprising:
deberthing the LNG carrier after the LNG carrier unloads; and
maintaining the storage vessel at the second of the at least two sets of structures.

47. The method of claim 46, further comprising deberthing the storage vessel in the event of adverse weather.

48. The method of claim 47, wherein the storage vessel is a barge and deberthing the storage vessel comprises moving the barge via maneuvering and propulsion systems disposed on the barge.

49. The method of claim 48, wherein the deberthing further comprises utilizing other vessels to move the barge.

50. The method of any of claims 47-49, wherein the storage vessel is another LNG carrier and deberthing the storage vessel comprises moving the another LNG carrier using a marine operation propulsion system disposed on the LNG carrier.

51. The method of claim 50, wherein deberthing further comprises assisting the movement of another LNG carrier utilizing other vessels.

52. The method of any of claims 44-51, wherein the facilities are on the platform and wherein the method comprises transferring LNG from the storage vessel to the facilities using the cryogenic cargo transfer equipment.

53. The method of any of claims 44-52, wherein the facilities are on the storage vessel, and wherein the method further comprises delivering vaporized LNG from the storage vessel to the platform using the transfer system and delivering the vaporized LNG to the pipeline.

54. The method of any of claims 44-53, wherein the storage vessel is a barge having tanks, the offloading further comprising filling the tanks with LNG using the cryogenic cargo transfer equipment.

55. The method of any of claims 44-54, wherein the storage vessel is another LNG carrier having tanks, the offloading further comprising filling the LNG carrier tanks with LNG using the cryogenic cargo transfer equipment.

56. A method for importing liquefied natural gas (LNG) comprising:
berthing and mooring a first LNG carrier at a first structure associated with an open-sea berth import terminal fixed to a seafloor and coupled to a pipeline in fluid communication with onshore facilities;
offloading LNG from the first LNG carrier to the open-sea berth import terminal using cryogenic cargo transfer equipment;
vaporizing the LNG from the first LNG carrier at the open-sea berth import terminal;
delivering the vaporized LNG to the pipeline;
berthing and mooring a second LNG carrier to a second structure associated with the open-sea berth import terminal to prepare cryogenic cargo transfer equipment for offloading while the first LNG carrier is offloading at the first structure;
initiating the offloading of LNG from the second LNG carrier after offloading of the LNG from the first LNG carrier is complete; and
preparing the first LNG carrier for deberthing while the second LNG carrier is offloading.

57. A method for importing liquefied natural gas (LNG) comprising:
berthing and mooring a first LNG carrier at a first structure associated with an open-sea berth import terminal fixed to a seafloor and coupled to a pipeline in fluid communication with onshore facilities;
berthing and mooring a second LNG carrier at a second structure associated with the open-sea berth import terminal;
transferring LNG from the first LNG carrier to the open-sea berth import terminal using cryogenic cargo transfer equipment;
vaporizing the LNG from the first LNG carrier at the open-sea berth import terminal; and
performing other offloading operations with the second LNG carrier concurrently with the transfer of LNG from the first LNG carrier.

58. The method of claim 57, further comprising delivering the vaporized LNG to the pipeline, while the second LNG carrier is performing other offloading operations.

59. The method of any of claims 57-58, wherein the other offloading operations comprise connecting, cooling down and disconnecting cryogenic cargo transfer equipment.

60. The method of any of claims 57-59, further comprising:
completing the offloading operation of the first LNG carrier; and
vaporizing the LNG from the second LNG carrier at the open-sea berth import terminal.

61. The method of claim 60, further comprising
delivering the vaporized LNG from the second LNG carrier to the pipeline.

62. The method of any of claims 60-61, further comprising:
deberthing the first LNG carrier from the first structure; and
berthing and mooring another LNG carrier at the first structure, while the second LNG carrier is transferring LNG.
